(19) United States
(12) Patent Application Publication
(10) Pub. No.: US 2025/0006931 A1
(43) Pub. Date: Jan. 2, 2025

(54) AQUEOUS SLURRY COMPOSITION FOR POSITIVE ELECTRODE, POSITIVE ELECTRODE MANUFACTURED THEREFROM, AND LITHIUM SECONDARY BATTERY

(71) Applicant: UIF (University Industry Foundation), Yonsei University, Seoul (KR)

(72) Inventors: Sang-Young LEE, Seoul (KR); Jung-Hui KIM, Seoul (KR); Won-Yeong KIM, Seoul (KR)

(73) Assignee: UIF (University Industry Foundation), Yonsei University, Seoul (KR)

(21) Appl. No.: 18/709,566

(22) PCT Filed: Sep. 5, 2023
(86) PCT No.: PCT/KR2023/013225

§ 371 Date: May 13, 2024

(30) Foreign Application Priority Data
Sep. 8, 2022 (KR) 10-2022-0114484
Aug. 10, 2023 (KR) 10-2023-0104709

(51) Int. Cl. H01M 4/62; H01M 4/02; H01M 4/04; H01M 4/13; H01M 4/139; H01M 10/052

(52) U.S. Cl. CPC H01M 4/62; H01M 4/0404; H01M 4/13; H01M 4/139; H01M 4/622; H01M 10/052; H01M 2004/028; H01M 2300/0011; H01M 2300/004

(57) ABSTRACT

An aspect of the present disclosure relates to an aqueous slurry composition for a positive electrode that can replace the existing positive electrode slurry composition using organic solvents and fluorine-based polymers. The aqueous slurry composition for a positive electrode contains an aqueous electrolyte containing a metal salt containing a kosmotropic anion and water, a positive electrode active material, and an aqueous polymer.

### TECHNICAL FIELD

The present disclosure relates to an aqueous slurry composition for a positive electrode that ensures chemical stability with a positive electrode active material vulnerable to moisture, and to a positive electrode and a lithium secondary battery manufactured therefrom.

### BACKGROUND ART

The electrodes for existing lithium secondary batteries are manufactured using carcinogenic organic solvents and fluorine-based polymers that are difficult to recycle. If this is replaced by an aqueous process using water, cellulose-based polymers, etc., it is not only environmentally friendly but also maximizes productivity. Therefore, researches on the aqueous process for manufacturing electrodes are actively underway.

However, side reactions between water and the existing electrode active material cause instability of the electrode active material, increase the basicity of water and cause corrosion of the current collector, thereby significantly reducing battery performance and lifetime characteristics. Although various attempts, such as addition of acids and current collector coating, have been reported as solutions to this problem, the root cause, i.e., the instability of the active material in the aqueous system, has not been solved. In particular, the use of high-capacity positive electrode active materials such as high-nickel lithium metal oxide is limited for water-based processes due to their high sensitivity to moisture.

### DISCLOSURE

### Technical Problem

In an aspect, the present disclosure is directed to providing an aqueous slurry composition for a positive electrode that can replace the existing positive electrode slurry composition using organic solvents and fluorine-based polymers by ensuring the stability of the positive electrode active material in the aqueous system.

In another aspect, the present disclosure is directed to providing a positive electrode manufactured from the aqueous slurry composition for a positive electrode and a lithium secondary battery including the same.

### Technical Solution

In another aspect, the present disclosure provides an aqueous slurry composition for a positive electrode, which contains an aqueous electrolyte containing water and a metal salt containing a kosmotropic anion; a positive electrode active material; and an aqueous polymer.

The kosmotropic anion may be selected from SO₄²⁻, CH₃COO⁻, C₂F₃O²⁻ (TFA⁻), Cl⁻, NO₃⁻, BF₄⁻, (PO₄)³⁻ and CF₃O₃S⁻ (OTf⁻).

The metal salt may contain a cation selected from Li⁺, Na⁺, K⁺, Mg²⁺, Al₃⁺ and Zn²⁺.

The metal salt may be lithium sulfate (Li₂SO₄), sodium sulfate (Na₂SO₄), magnesium sulfate (MgSO₄), zinc sulfate (ZnSO₄), lithium phosphate (Li₃PO₄) or a combination thereof.

The aqueous electrolyte may contain the metal salt at a concentration of 0.1 to 2.0 M.

The content of the positive electrode active material relative to the total weight of the aqueous slurry composition for a positive electrode may be 40 to 60% by weight.

The aqueous electrolyte and the aqueous polymer may be included at a weight ratio of 1:0.01 to 0.1.

The aqueous polymer may be cellulose, polyacrylic acid, polyacrylamide, polyacrylonitrile, polyvinyl alcohol, polyvinyl acetate, polyvinylpyrrolidine, polyethylene, polystyrene, polyurethane, styrene-butadiene rubber, or a combination thereof.

In an aspect, the aqueous slurry composition for a positive electrode may further contain a conductive material.

In another aspect, the present disclosure provides a positive electrode including: a positive electrode current collector; and a positive electrode active material layer prepared from the above-described aqueous slurry composition for a positive electrode on one or both sides of the positive electrode current collector.

In another aspect, the present disclosure provides a lithium secondary battery including the above-described positive electrode.

A method for manufacturing a positive electrode according to an aspect of the present disclosure may include: a step of preparing an aqueous electrolyte containing a metal salt containing a kosmotropic anion and water; a step of preparing an aqueous slurry composition for a positive electrode by mixing a lithium positive electrode active material and an aqueous polymer with the aqueous electrolyte; and a step of forming a positive electrode active material layer by applying the aqueous slurry composition for a positive electrode to one surface of the positive electrode current collector and heat-treating the same.

The heat treatment may be performed at a temperature of 25 to 120° C.

### Advantageous Effects

An aqueous slurry composition for a positive electrode according to an aspect of the present disclosure can ensure the chemical stability of a positive electrode active material which is vulnerable to moisture even in an aqueous system. Specifically, the aqueous slurry composition for a positive electrode according to an aspect can suppress pH changes caused by chemical side reactions at the interface between the positive electrode active material and water, and through this, a positive electrode with a stable interfacial structure and excellent charge-discharge performance can be manufactured. In particular, the aqueous slurry composition for a positive electrode according to an aspect can be applied to high-capacity positive electrode active materials such as high-nickel lithium metal oxide, which is very vulnerable to moisture.

In addition, the aqueous slurry composition for a positive electrode according to an aspect is not only environmentally friendly, but can also significantly improve the productivity of electrode manufacturing. Specifically, it is harmless to the human body and the environment because it does not use organic solvents and fluorine-based polymers, and production cost can be reduced significantly because the materials used are very inexpensive and the solvent recovery process can be shortened as compared to existing organic solvent processes.

### BRIEF DESCRIPTION OF DRAWINGS

FIG. 1 schematically shows aqueous slurry compositions for a positive electrode according to Example 1 and Comparative Example 1.

### BEST MODE

Unless defined otherwise herein, all technical and scientific terms have the same meaning as commonly understood by a person skilled in the art to which the present disclosure pertains. The terminology used in the present specification is merely intended to describe particular embodiments effectively, not to limit the present disclosure.

As used herein, the singular forms are intended to include the plural forms as well, unless the context clearly dictates otherwise.

Throughout this specification, “include”, “comprise”, “contain” or “have” does not exclude other elements, materials or processes, but rather includes other elements, materials or processes, unless specifically stated to the contrary.

Numerical ranges used herein include lower and upper limits and all values within that ranges, increments logically derived from the shape and width of the ranges being defined, all doubly defined values, and upper and lower limits of numerical ranges defined in different forms. Unless specified otherwise herein, values outside the numerical range that may occur due to experimental error or rounding of values are also included in the defined numerical range.

Unless defined otherwise herein, when a part of a layer, film, thin film, region, plate, etc. is said to be “on” or “over” another part, this includes the presence of the part not only “directly on” the other part, but also with another part between them.

Hereinafter, the present disclosure will be described in detail. However, the following description is merely illustrative and the present disclosure is not limited to the specific embodiments described by way of examples.

In an aspect, the present disclosure provides an aqueous slurry composition for a positive electrode that can ensure the chemical stability of a positive electrode active material which is vulnerable to moisture.

Specifically, an aqueous slurry composition for a positive electrode according to an aspect includes: an aqueous electrolyte containing a metal salt containing a kosmotropic anion and water; a positive electrode active material; and an aqueous polymer.

The aqueous slurry composition for a positive electrode according to an aspect, which uses a combination of an aqueous electrolyte containing a metal salt containing a kosmotropic anion and an aqueous polymer, can ensure the stability for a positive electrode active material with high sensitivity to moisture. In particular, the aqueous slurry composition for a positive electrode according to an aspect may be applicable to high-capacity positive electrode active materials such as high-nickel lithium metal oxide, which is very vulnerable to moisture.

The kosmotropic anion refers to an anion with high kosmotropicity, and may refer to an anion with higher kosmotropicity than bis(trifluoromethanesulfonyl)imide (TFSI⁻). It can stabilize the structure of water due to strong interaction with water molecules. Through this, the activity of water molecules can be decreased, the stability of the positive electrode active material can be ensured by effectively suppressing the reaction between the positive electrode active material and water molecules, and a positive electrode with a stable interfacial structure and excellent charge/discharge performance can be manufactured.

The kosmotropic anion may be, for example, SO₄²⁻, OAc⁻, C₂F₃O₂⁻ (TFA⁻), Cl⁻, NO₃⁻, BF₄⁻, (PO₄)³⁻, CF₃O₃S⁻ (OTf⁻) or a combination thereof, specifically, SO₄²⁻ or (PO₄)³⁻. It may further improve the stability of the positive electrode active material. The cation of the metal salt according to an aspect is not particularly limited as long as it is a metal cation that pairs with the kosmotropic anion. It may be, for example, Li⁺, Na⁺, K⁺, Mg²⁺, Al³⁺, Zn²⁺ or a combination thereof. For example, it may be an alkali metal cation, e.g., Li⁺ or Na⁺.

The metal salt containing a kosmotropic anion according to an aspect may be, for example, lithium sulfate (Li₂SO₄), sodium sulfate (Na₂SO₄), magnesium sulfate (MgSO₄), zinc sulfate (ZnSO₄) or lithium phosphate (Li₃PO₄). More specifically, it may be lithium sulfate (Li₂SO₄), sodium sulfate (Na₂SO₄) or magnesium sulfate (MgSO₄). It may more effectively suppress the reaction between the positive electrode active material and water molecules.

The aqueous electrolyte may contain the metal salt at a concentration of 0.1 M or higher, 0.5 M or higher, 5.0 M or lower, 3.0 M or lower, 2.0 M or lower, or 1.0 M or lower, specifically, 0.1 to 5.0 M, 0.1 to 3.0 M, 0.1 to 2.0 M, 0.5 to 2.0 M, or 0.5 to 1.0 M. In this case, the stability of the positive electrode active material against moisture can be improved further.

The content of the positive electrode active material relative to the total weight of the positive electrode slurry composition may be 40 to 70% by weight, 40 to 60% by weight, or 40 to 50% by weight.

The aqueous electrolyte and the aqueous polymer may be included in a weight ratio of 1:0.01 to 0.1, or 0.01 to 0.05.

If the above content is satisfied, it is preferred because it can further improve battery performance and lifetime characteristics, although not being necessarily limited thereto.

The aqueous polymer is not particularly limited as long as it is one commonly used in the relevant technical field. Non-limiting examples include cellulose, polyacrylic acid, polyacrylamide, polyacrylonitrile, polyvinyl alcohol, polyvinyl acetate, and polyvinylpyrrolidine, polyethylene, polystyrene, polyurethane, styrene-butadiene rubber, or a combination thereof. More specifically, it may be cellulose, polyacrylic acid, or a combination thereof, and the cellulose may include carboxymethyl cellulose, methyl cellulose, hydroxyethyl cellulose and hydroxypropyl cellulose.

The positive electrode active material may be a typical positive electrode active material used in this technical field, and non-limiting examples include lithium cobalt oxide (LiCoO₂), spinel crystalline lithium manganese oxide (LiMn₂O₄), lithium manganese oxide (LiMnO₂), lithium nickel oxide (LiNiO₂), lithium iron phosphate (LiFePO₄), lithium manganese phosphate (LiMnPO₄), lithium cobalt phosphate (LiCoPO₄), lithium iron pyrophosphate (Li₂FeP₂O₇), lithium niobium oxide (LiNbO₂), lithium iron oxide (LiFeO₂), lithium magnesium oxide (LiMgO₂), lithium copper oxide (LiCuO₂), lithium zinc oxide (LiZnO₂), lithium molybdenum oxide (LiMoO₂), lithium tantalum oxide (LiTaO₂), lithium tungsten oxide (LiWO₂), lithium manganese nickel cobalt oxide (xLi₂MnO₃(1-x)LiMn_{1-y-z}Ni_{y}CO_{z}O₂), lithium nickel cobalt aluminum oxide (LiNi_{0.8}Co_{0.15}Al_{0.05}O₂), lithium nickel manganese nickel oxide (LiNi_{0.5}Mn_{1.5}O₄), lithium nickel cobalt manganese oxide (LiNi_{0.33}Co_{0.33}Mn_{0.33}O₂, LiNi_{0.4}Co_{0.2}Mn_{0.4}O₂, LiNi_{0.5}Co_{0.2}Mn_{0.3}O₂, LiNi_{0.6}Co_{0.2}Mn_{0.2}O₂, LiNi_{0.7}Co_{0.15}Mn_{0.15}O₂, LiNi_{0.8}Co_{0.1}Mn_{0.1}O₂), etc., although not being limited thereto.

In particular, the aqueous slurry composition for a positive electrode according to an embodiment has the advantage that it is highly miscible with a high-capacity positive electrode material such as lithium nickel cobalt manganese oxide containing nickel at a content of 60 mol % or more, e.g., NCM811 ((LiNi_{0.8}Co_{0.1}Mn_{0.1}O₂), etc.

The aqueous slurry composition for a positive electrode may further contain a conductive material.

The conductive material is not particularly limited as long as it is one commonly used in the relevant technical field. Non-limiting examples may include a carbon-based conductive material, and the carbon-based conductive material may include a point-type carbon-based conductive material, a linear carbon-based conductive material, a plate-type carbon-based conductive material, or a mixture thereof. The point-type carbon-based conductive material include acetylene black, Ketjen black, channel black, furnace black, lamp black, thermal black, carbon black, etc., the linear carbon-based conductive material includes carbon nanotube, conductive carbon fiber, etc. and the plate-type carbon-based conductive material includes graphene (including GRO).

In another aspect, the present disclosure provides a positive electrode manufactured from the above-described aqueous slurry composition for positive electrode.

Specifically, the positive electrode according to an aspect may include: a positive electrode current collector; and a positive electrode active material layer formed on at least one side of the positive electrode current collector and prepared from the aqueous slurry composition for a positive electrode according to an embodiment.

Non-limiting examples of the positive electrode current collector may include aluminum, copper, nickel, titanium, zinc, carbon or a combination thereof. Specifically, it may be aluminum.

The positive electrode according to an aspect may be prepared by a step of preparing an aqueous electrolyte containing a metal salt containing a kosmotropic anion and water; a step of preparing an aqueous slurry composition for a positive electrode by mixing a positive electrode active material and an aqueous polymer with the aqueous electrolyte; and a step of forming a positive electrode active material layer by applying the aqueous slurry composition for a positive electrode to one surface of the positive electrode current collector and heat-treating the same.

The application may be performed using a conventional application method, and specific examples include spray coating, dip coating, spin coating, gravure coating, slot die coating, doctor blade coating, roll coating, inkjet printing, lexography printing, screen printing, electrohydrodynamic printing, microcontact printing, imprinting, reverse offset printing, bar coating, etc., although not being limited thereto.

The heat treatment may be performed at a temperature of 25 to 120° C., or 25 to 60° C.

In another aspect, the present disclosure provides a lithium secondary battery including the above-described positive electrode.

Hereinafter, the lithium secondary battery according to an aspect will be described. Of course, it can be manufactured using conventional manufacturing methods and materials known in the art, except that it includes a positive electrode manufactured from the aqueous slurry composition for positive electrode according to an aspect.

The lithium secondary battery according to an aspect may include a positive electrode prepared from the aqueous slurry composition for a positive electrode, a negative electrode, and an electrolyte.

The negative electrode may include a negative electrode current collector and a negative electrode active material layer formed on the negative electrode current collector.

Non-limiting examples of the negative electrode current collector may be selected from a foil made of copper, gold, nickel, copper alloy, or a combination thereof. The negative electrode active material layer may be made of a carbon material selected from soft carbon, hard carbon, artificial graphite, natural graphite, expandable graphite, carbon fiber, non-graphitizable carbon, carbon black, carbon nanotube, acetylene black, Ketjen black, graphene, fullerene, activated carbon and mesocarbon microbeads; a metal selected from silicon, tin, lithium, aluminum, silver, bismuth, indium, germanium, lead, platinum, titanium, zinc, manganese, cadmium, cerium, copper, cobalt, nickel and iron; an alloy containing two or more of the above metals; and one or more oxide of the above metals. Specifically, it may be made of lithium metal, although not being limited thereto.

The electrolyte may be a liquid electrolyte, a solid electrolyte or a combination thereof. Specifically, it may be a liquid electrolyte, and the liquid electrolyte may include a non-aqueous organic solvent and a lithium salt.

The non-aqueous organic solvent may be selected from cyclic carbonate-based solvents, linear carbonate-based solvents, and mixed solvents thereof. The cyclic carbonate-based solvents may be selected from a group consisting of ethylene carbonate, propylene carbonate, butylene carbonate, vinylene carbonate, and vinylethylene carbonate, fluoroethylene carbonate and mixtures thereof, and the linear carbonate-based solvents may be selected from a group consisting of dimethyl carbonate, diethyl carbonate, dipropyl carbonate, ethyl methyl carbonate, methyl propyl carbonate, methyl isopropyl carbonate, ethyl propyl carbonate and mixtures thereof.

The lithium salt includes one or more selected from a group consisting of LiPF₆, LiBF₄, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlO₄, LiAlCl₄, LiCl and LiI, although not being limited thereto. The concentration of the lithium salt may be 0.6 M to 2.0 M.

In addition, the lithium secondary battery according to an aspect may further include a separator, and the separator is not limited as long as it is one commonly used in the relevant technical field. Non-limiting examples may include one selected from, for example, glass fiber, polyester, polyethylene, polypropylene, polytetrafluoroethylene or a combination thereof. It may be in the form of a non-woven fabric or a woven fabric, and may optionally have a single-layer or multi-layer structure.

The shape of the lithium secondary battery according to an aspect is not particularly limited as long as it can accommodate a positive electrode, a negative electrode, a separator and an electrolyte, and may be in the form of, for example, a cylinder, a coin, a pouch, a plate or a laminate.

Hereinafter, the above-described exemplary embodiments will be described in more detail through examples. However, the following examples are for illustrative purposes only and do not limit the scope of the present disclosure.

### EXAMPLE 1

### Preparation of Aqueous Slurry Composition for Positive Electrode

An aqueous electrolyte was prepared by mixing lithium sulfate (Li₂SO₄) with water at a concentration of 0.5 M. An aqueous slurry composition for a positive electrode was prepared by mixing, in the aqueous electrolyte, positive electrode active material (LiNi_{0.8}Mn_{0.1}Co_{0.1}O₂, NCM811)/carbon black/carboxymethyl cellulose (CMC)/polyacrylic acid (PAA) at a weight ratio of 94/3/1.5/1.5, so that the content of the positive electrode material was 55% by weight.

### Manufacturing of Positive Electrode

The aqueous slurry composition for the positive electrode was applied to an aluminum (Al) current collector with a thickness of 18 μm using a doctor blade and vacuum-dried at 40° C. for 12 hours to form a positive electrode active material layer with a thickness of 80 μm.

### Manufacturing of Lithium Secondary Battery

The positive electrode prepared above and a negative electrode in which lithium metal with a thickness of 100 μm was rolled on a copper foil current collector with a thickness of 8 μm were used as counter electrodes. After placing a polyethylene separator (Donen Co., Ltd., F20BHE, thickness=16 μm) between the positive electrode and the negative electrode, an electrolyte (1 M hexafluorophosphate (LiPF₆), ethylene carbonate/dimethyl carbonate/vinylene carbonate=1:1:0.02 by volume) was injected to prepare a coin cell type battery.

### EXAMPLES 2 AND 3

The same procedure as Example 1 was carried out, except that the concentration of lithium sulfate was changed to 1.0 M and 2.0 M, respectively, when preparing the aqueous electrolyte.

### EXAMPLES 4 AND 5

The same procedure as Example 1 was carried out, except that sodium sulfate (Na₂SO₄) and magnesium sulfate (MgSO₄) were used instead of lithium sulfate, respectively, when preparing the aqueous electrolyte.

### COMPARATIVE EXAMPLE 1

The same procedure as Example 1 was carried out, except that pure water was used instead of the aqueous electrolyte containing lithium sulfate when preparing the aqueous slurry composition for a positive electrode.

### COMPARATIVE EXAMPLE 2

The same procedure as Example 1 was carried out, except that LiTFSI was used instead of lithium sulfate (Li₂SO₄) when preparing the aqueous electrolyte.

### COMPARATIVE EXAMPLE 3

The same procedure as Example 1 was carried out, except that N-methylpyrrolidone (NMP) was used instead of the aqueous electrolyte and polyvinylidene fluoride (PVdF) was used instead of CMC and PAA as the binder.

### Evaluation Example

### 1. Evaluation of Lifetime Characteristics

The lifetime characteristics of the lithium secondary batteries manufactured in the examples and comparative examples were analyzed at room temperature. Specifically, the initial charge/discharge capacity of each lithium secondary battery was observed at room temperature (25° C.) in a voltage range of 3.00 to 4.25 V at the current of 0.1 C (=0.4 mA/cm²), and charging/discharging was repeated 200 cycles at the current of 0.2 C/0.5 C (=2.0 mA/cm²). Then, capacity retention rate (%) was calculated as a percentage of the discharge capacity at the 200th cycle divided by the discharge capacity at the 1st cycle. The result is shown in Table 1 below.

TABLE 1

| | Example | | | Comparative Example | | |
|---|---|---|---|---|---|---|
| | 1 | 2 | 3 | 1 | 2 | 3 |
| Capacity retention rate (%) | 89.4 | 88.3 | 86.2 | 77.7 | 74.4 | 91.3 |

Referring to Table 1, it can be seen that the lithium secondary batteries including the positive electrodes manufactured from the aqueous slurry compositions for a positive electrode according to Examples 1 to 3 of the present disclosure exhibited capacity retention rate similar to that of the lithium secondary battery including the positive electrode manufactured using an organic solvent and a fluorine-based polymer binder (Comparative Example 3). In addition, it was confirmed that the lithium secondary batteries including the positive electrode according to Examples 4 and 5 also had excellent capacity retention rate. On the other hand, the lifetime characteristics of the lithium secondary batteries of Comparative Examples 1 and 2 were deteriorated. That is to say, the aqueous slurry composition for a positive electrode according to an aspect of the present disclosure can ensure the stability of a positive electrode active material that is vulnerable to moisture and can provide a positive electrode with a stable interfacial structure and excellent charge-discharge performance.

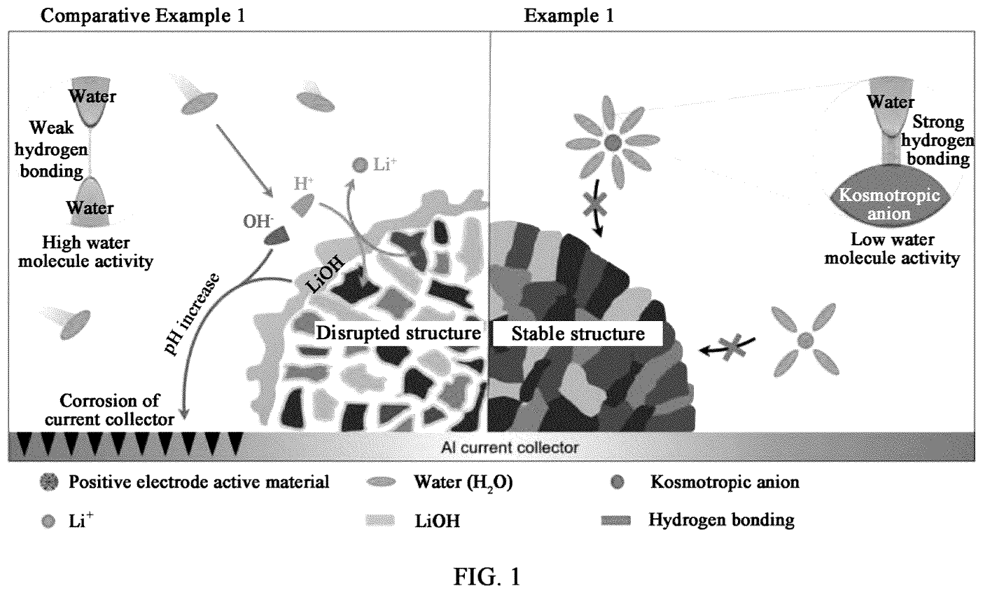

FIG. 1 schematically shows the aqueous slurry compositions for a positive electrode according to Example 1 and Comparative Example 1. In the case of Comparative Example 1, it can be seen that the activity of water is high, side reactions between water and the positive electrode active material occur, the basicity of water is increased, and the corrosion of the current collector occurs due to the absence of kosmotropic anions. On the other hand, in Example 1, the reactivity of the NCM811 positive electrode active material, which is vulnerable to moisture, to water could be suppressed and pH change could be suppressed by reducing the activity of water. As a result, it is possible to manufacture a positive electrode with a stable interfacial structure and excellent charge-discharge performance.

Although the present disclosure has been described above through limited exemplary embodiments, they are provided only to facilitate a more general understanding of the present disclosure, and the present disclosure is not limited to the above exemplary embodiments. Anyone who has common knowledge in the field to which the present disclosure pertains can make various modifications and variations based on this description.

Accordingly, the scope of the present disclosure should not be limited to the described exemplary embodiments, and the scope of the appended claims described below as well as all modifications that are equivalent to the scope of the claims shall fall within the scope of the present disclosure.

We claim:

1. An aqueous slurry composition for a positive electrode, comprising: an aqueous electrolyte comprising a metal salt comprising a kosmotropic anion and water; a positive electrode active material; and an aqueous polymer.

2. The aqueous slurry composition for a positive electrode according to claim 1, wherein the kosmotropic anion is selected from SO₄²⁻, CH₃COO⁻, C₂F₃O²⁻ (TFA⁻), Cl⁻, NO₃⁻, BF₄⁻, (PO₄)³⁻ and CF₃O₃S⁻ (OTf⁻).

3. The aqueous slurry composition for a positive electrode according to claim 1, wherein the metal salt comprises a cation selected from Li⁺, Na⁺, K⁺, Mg²⁺, Al³⁺ and Zn²⁺.

4. The aqueous slurry composition for a positive electrode according to claim 1, wherein the metal salt is lithium sulfate (Li₂SO₄), sodium sulfate (Na₂SO₄), magnesium sulfate (MgSO₄), zinc sulfate (ZnSO₄), lithium phosphate (Li₃PO₄) or a combination thereof.

5. The aqueous slurry composition for a positive electrode according to claim 1, wherein the aqueous electrolyte comprises the metal salt at a concentration of 0.1 to 2.0 M.

6. The aqueous slurry composition for a positive electrode according to claim 1, which comprises the positive electrode active material at a content of 40 to 60% by weight relative to the total weight of the aqueous slurry composition for a positive electrode.

7. The aqueous slurry composition for a positive electrode according to claim 1, which comprises the aqueous electrolyte and the aqueous polymer at a weight ratio of 1:0.01 to 0.1.

8. The aqueous slurry composition for a positive electrode according to claim 1, wherein the aqueous polymer is cellulose, polyacrylic acid, polyacrylamide, polyacrylonitrile, polyvinyl alcohol, polyvinyl acetate, polyvinylpyrrolidine, polyethylene, polystyrene, polyurethane, styrene-butadiene rubber or a combination thereof.

9. The aqueous slurry composition for a positive electrode according to claim 1, wherein the aqueous slurry composition for a positive electrode further comprises a conductive material.

10. A positive electrode comprising: a positive electrode current collector; and a positive electrode active material layer prepared from the aqueous slurry composition for a positive electrode according to claim 1 on one or both sides of the positive electrode current collector.

11. A lithium secondary battery comprising the positive electrode according to claim 10.

12. A method of manufacturing a positive electrode comprising: a step of preparing an aqueous electrolyte comprising a metal salt containing a kosmotropic anion and water; a step of preparing an aqueous slurry composition for a positive electrode by mixing a lithium positive electrode active material and an aqueous polymer with the aqueous electrolyte; and a step of forming a positive electrode active material layer by applying the aqueous slurry composition for a positive electrode to one surface of a positive electrode current collector and heat-treating the same.

13. The method of manufacturing a positive electrode according to claim 12, wherein the heat treatment is performed at a temperature of 25 to 120° C.
